(19) United States
(12) Patent Application Publication
(10) Pub. No.: US 2010/0123647 A1
(43) Pub. Date: May 20, 2010

(54) DISPLAY APPARATUS AND METHOD OF DRIVING THE SAME

(75) Inventors: Nam-Hee Goo, Gunsan-si (KR); Bong-Hyun You, Yongin-si (KR); Hee-Bum Park, Sungnam-si (KR); Hee-Jin Choi, Seoul (KR)

Correspondence Address: CANTOR COLBURN, LLP, 20 Church Street, 22nd Floor, Hartford, CT, 06103, US

(73) Assignee: Samsung Electronics Co, Ltd., Suwon-si (KR)

(21) Appl. No.: 12/434,152

(22) Filed: May 1, 2009

(30) Foreign Application Priority Data
Nov. 19, 2008 (KR) 10-2008-0115297

(51) Int. Cl. G09G 3/20; G09G 3/36

(52) U.S. Cl. 345/55; 345/87

(57) ABSTRACT

A display apparatus includes: a display panel including gate lines, data lines and pixels; a gate driver connected to the gate lines and which transmits a first gate signal and a second gate signal to the gate lines; and a data driver connected to the data lines and which transmits a normal data signal and an impulsive data signal to the data lines. The pixels receive the normal data signal in response to the first gate signal and receive the impulsive data signal in response to the second gate signal. The gate lines are divided into a first group and a second group adjacent to the first group. An order in which the first gate signal is transmitted to the gate lines in the first group is different from an order in which the first gate signal is transmitted to the gate lines in the second group.

This application claims priority to Korean Patent Application No. 10-2008-0115297, filed on Nov. 19, 2008, and all the benefits accruing therefrom under 35 U.S.C. §119, the contents of which in its entirety are herein incorporated by reference.

### BACKGROUND OF THE INVENTION

1. Field of the Invention

The present invention relates to a display apparatus and a method of driving the same, and more particularly, to a display apparatus with substantially improved display quality and a method of driving the display apparatus.

2. Description of the Related Art

Display apparatus such as an organic light emitting device (OLED), a plasma display panel (PDP), and a liquid crystal display (LCD) have been actively developed as substitutes for the cathode ray tube (CRT), which may be heavy and large. A PDP is a device that displays characters or images using plasma generated by a gas-discharge, and an OLED is a device that displays characters or images using electroluminescence of a specific organic material or high molecular weight polymeric compounds. A liquid crystal display (“LCD”) typically includes a first display substrate, a second display substrate and a dielectrically anisotropic liquid crystal layer interposed between the first display substrate and the second display substrate. The first substrate has a plurality of pixel electrodes disposed thereon. The second substrate has a common electrode disposed thereon. Otherwise, the first substrate may have a common electrode disposed thereon. The plurality of pixel electrodes is arranged in a substantially matrix pattern and is connected to switching devices such as thin-film transistors (“TFTs”), for example. A data voltage is applied to a corresponding pixel electrode. The common electrode receives a common voltage. The liquid crystal layer, interposed between the first substrate and the second substrate, forms a liquid crystal capacitor, and the liquid crystal capacitor and the switching device connected to the liquid crystal capacitor form a basic unit of a pixel.

The LCD generates an electric field in the liquid crystal layer by applying voltages to the pixel electrodes and the common electrode and controls an intensity of the electric field to control an amount of light transmitted through the liquid crystal layer. Thus, the LCD displays a desired image. However, when an electric field aligned in a given direction is applied to the liquid crystal layer for an extended amount of time, a display quality of the LCD is substantially degraded. To prevent this problem, a polarity of the data voltage is inverted, with respect to a polarity of the common voltage, based on units of frames, rows, columns or pixels, for example. However, when the polarity of the data voltage is inverted as described above, a response time of liquid crystal molecules in the liquid crystal layer is substantially reduced. Thus, a time required for the liquid crystal capacitor to charge to a target voltage level is substantially increased, thereby causing screen blurring in the LCD.

To address this problem, driving methods such as a black insertion driving method in which black images are inserted into specific regions of the screen of an LCD, or, alternatively, an impulsive driving method, have been developed. However, when a plurality of gate lines are divided into a plurality of groups and a gate-on signal is transmitted to each of the groups such that black data (or impulsive data) is inserted into the groups, a large difference between a normal data output time of a last gate line in each group and a normal data output time of a first gate line in a next group develops. Thus, bright lines, caused by a discontinuous difference in gray level, are formed, thereby substantially degrading display quality of the LCD.

### BRIEF SUMMARY OF THE INVENTION

Exemplary embodiments of the present invention provide a display apparatus with substantially improved display quality.

Exemplary embodiments of the present invention also provide a method of driving an display apparatus with substantially improved display quality.

According to an exemplary embodiment of the present invention, an display apparatus includes: a display panel including gate lines, data lines which cross the gate lines and pixels electrically connected to the gate lines and the data lines and which display images; a gate driver electrically connected to the gate lines and which transmits a first gate signal and a second gate signal to the gate lines; and a data driver electrically connected to the data lines and which transmits normal data voltages and impulsive data voltages to the data lines. The pixels receive the normal data voltages in response to the first gate signal, and receive the impulsive data voltages in response to the second gate signal. The gate lines are divided into at least one first group and at least one second group disposed adjacent to the at least one first group. An order in which the first gate signal is transmitted to the gate lines in the at least one first group is different from an order in which the first gate signal is transmitted to the gate lines in the at least one second group.

According to an exemplary embodiment of the present invention, a display apparatus includes: a display panel comprising: gate lines, data lines which cross the gate lines and pixels electrically connected to the gate lines and the data lines, which display an image; a gate driver electrically connected to the gate lines, which transmits a first gate signal and a second gate signal to the gate lines; a data driver electrically connected to the data lines, which transmits normal data voltages and impulsive data voltages to the data lines; and a signal controller. the pixels receive the normal data voltages in response to the first gate signal. the pixels receive the impulsive data voltages in response to the second gate signal. the gate lines are divided into at least one first group and at least one second group. The at least one first group is disposed adjacent to the at least one second group. And an order in which the first gate signal is transmitted to the gate lines in the at least one first group is different from an order in which the first gate signal is transmitted to the gate lines in the at least one second group the signal controller receives original image signals. the signal controller generates the normal data signals which is corresponding to the normal data voltages, by changing an order of the original image signals based on at least one of the order in which the first gate signal is transmitted to the gate lines in the at least one first group and the order in which the first gate signal is transmitted to the gate lines in the at least one second group.

According to an exemplary embodiment of the present invention, a method of driving an display apparatus includes: providing a display panel including gate lines, data lines which cross the gate lines and pixels electrically connected to the gate lines and the data lines and which display images; transmitting a first gate signal and a second gate signal to the gate lines; and transmitting normal data voltages and impulsive data voltages to the data lines. The pixels receive the normal data voltages in response to the first gate signal, and receive the impulsive data voltages in response to the second gate signal. The gate lines are divided into at least one first group and at least one second group disposed adjacent to the at least one first group. An order in which the first gate signal is transmitted to the gate lines in the at least one first group is different from an order in which the first gate signal is transmitted to the gate lines in the at least one second group.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of an exemplary embodiment of a liquid crystal display (“LCD”) and an exemplary embodiment of a method of driving the same according to the present invention;

FIG. 2 is an equivalent circuit diagram of a pixel included in an exemplary embodiment of a display panel of the LCD shown in FIG. 1;

FIG. 3 is a block diagram of a signal controller of the LCD shown in FIG. 1;

FIG. 4 is a signal timing diagram for explaining an exemplary embodiment of transmitting a first gate signal and a second gate signal to a plurality of gate lines of the LCD shown in FIG. 1;

FIG. 5 is a signal timing diagram illustrating an exemplary embodiment of a normal data output time and an impulsive data output time of each of gate line of the plurality of gate lines shown in FIG. 4;

FIG. 6 is a graph of gate line number versus brightness illustrating an exemplary embodiment of a variation in brightness of the gate lines shown in FIG. 4;

FIG. 7 is a signal timing diagram illustrating images displayed on the display panel shown in FIG. 2; and

FIG. 8 is a signal timing diagram for explaining an exemplary embodiment of a method of generating normal data signals using the signal controller shown in FIG. 3.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, a liquid crystal display (“LCD”) and a method of driving the same according to an exemplary embodiment of the present invention will be described in further detail with reference to the accompanying drawings.

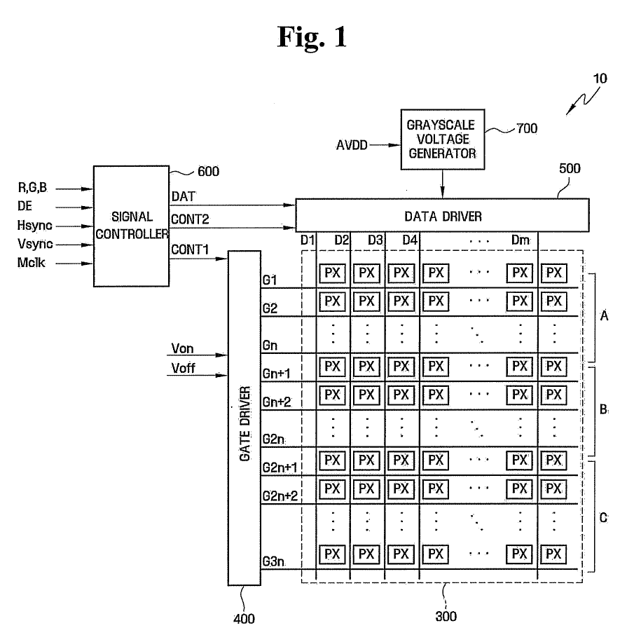

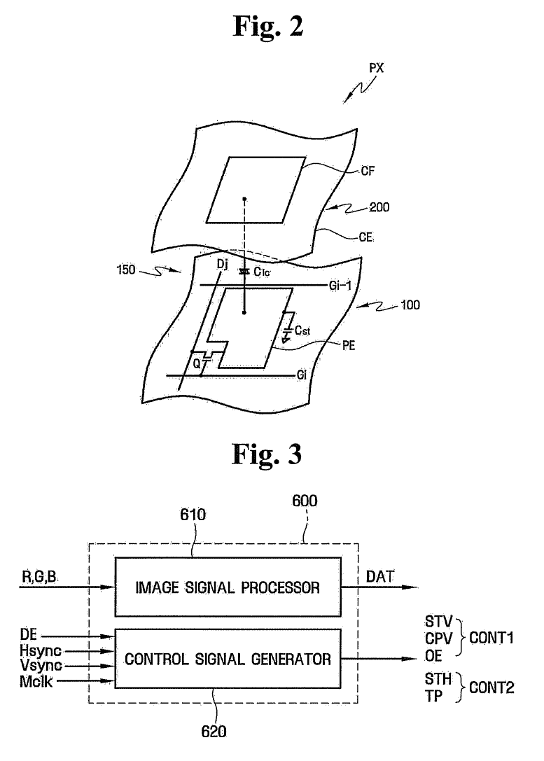

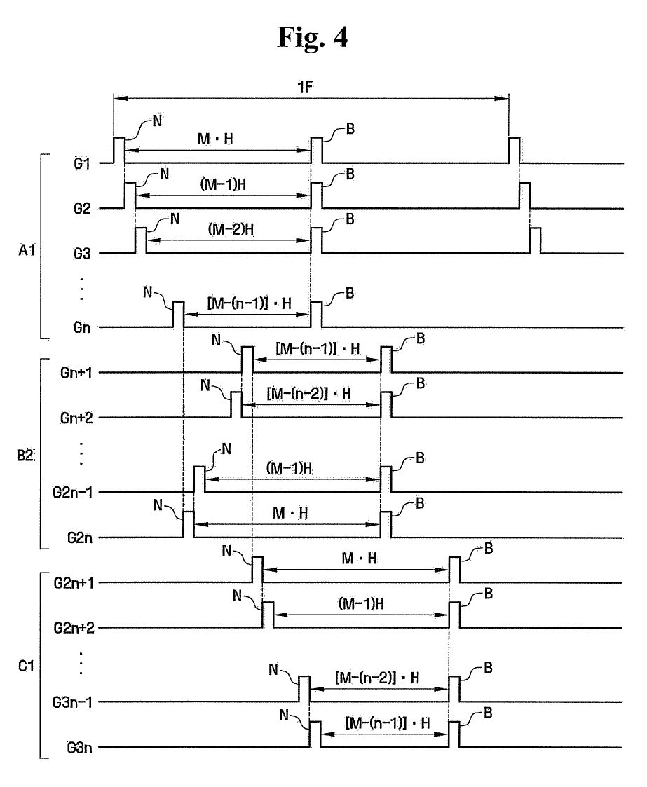

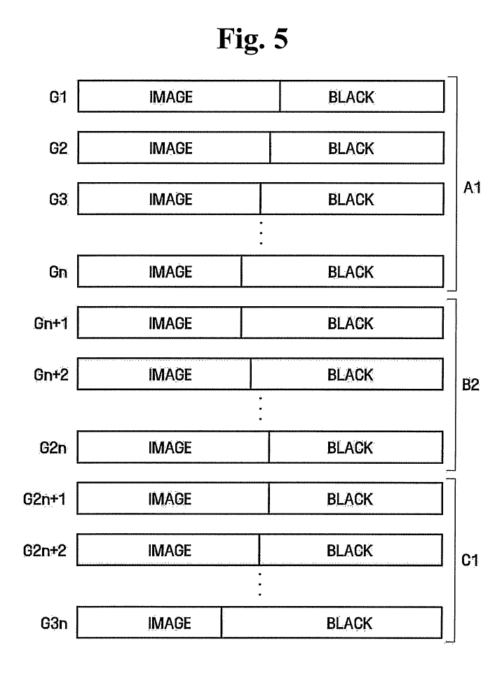

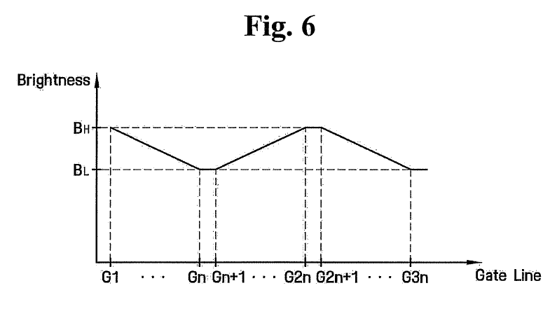

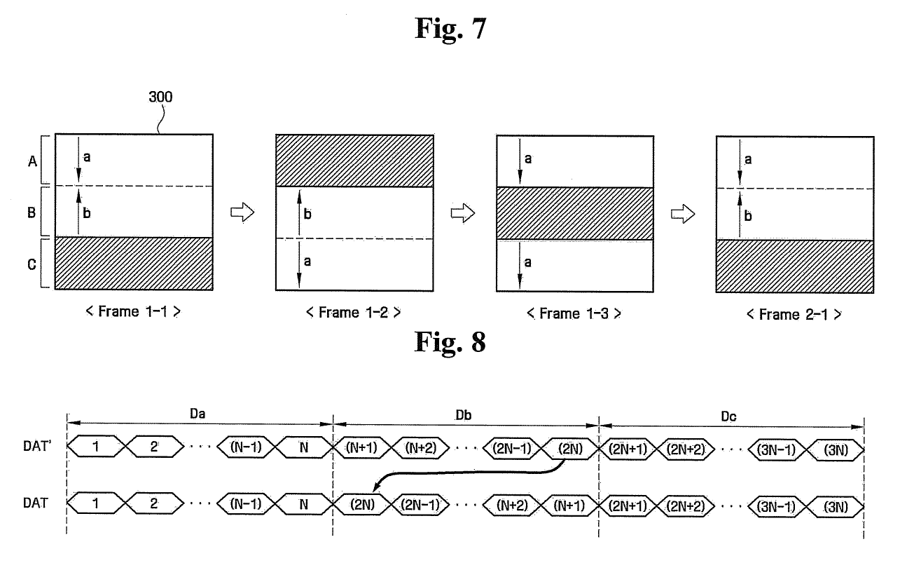

FIG. 1 is a block diagram of an exemplary embodiment of an LCD 10 and a method of driving the same according to the present invention. FIG. 2 is an equivalent circuit diagram of a pixel PX included in an exemplary embodiment of a display panel 300 of the LCD 10 shown in FIG. 1. FIG. 3 is a block diagram of an exemplary embodiment of a signal controller 600 of the LCD 10 shown in FIG. 1. FIG. 4 is a signal timing diagram for explaining an exemplary embodiment of a process of transmitting a first gate signal and a second gate signal to first through (3n)^{th} gate lines G1 through G3n of the LCD 10. FIG. 5 is a signal timing diagram illustrating an exemplary embodiment of a normal data output time and an impulsive data output time of each of the first through (3n)^{th} gate lines G1 through G3n shown in FIG. 4. FIG. 6 is a graph of gate line numbers versus brightness illustrating an exemplary embodiment of a variation in brightness of the first through (3n)^{th} gate lines G1 through G3n shown in FIG. 4. FIG. 7 is a timing signal diagram images displayed on the display panel 300. FIG. 8 is a signal timing diagram for explaining an exemplary embodiment of a method of generating normal data signals using the signal controller 600 shown in FIG. 3.

Referring to FIG. 1, the LCD 10 according to an exemplary embodiment includes the display panel 300, the signal controller 600, a gate driver 400, a data driver 500 and a grayscale voltage generator 700.

The display panel 300 includes the first through (3n)^{th} gate lines G1 through G3n, respectively, first through m^{th} data lines D1 through Dm, respectively, and a plurality of pixels PX. The first through (3n)^{th} gate lines G1 through G3n extend in a substantially first direction and substantially parallel to each other, and the first through m^{th} data lines D1 through Dm extend in a substantially second direction and substantially parallel to each other. In an exemplary embodiment, the plurality of pixels PX are disposed in regions in which the first through (3n)^{th} gate lines G1 through G3n cross the first through m^{th} data lines D1 through Dm, respectively. The gate driver 400 transmits gate signals to the first through (3n)^{th} gate lines G1 through G3n, and the data driver 500 transmits data voltages to the first through m^{th} data lines D1 through Dm. The plurality of pixels PX display images in response to the data voltages, respectively.

In an exemplary embodiment, the gate signals are transmitted to the gate lines G1 through G3n and include first gate signals and second gate signals. In addition, the data voltages applied to the data lines D1 through Dm include normal data voltages and impulsive data voltages. The pixels PX receive the normal data voltages in response to the first gate signals, and the pixels PX receive the impulsive data voltages in response to the second gate signals.

More specifically, the first through (3n)^{th} gate lines G1 through G3n are divided into a plurality of sections (e.g., parts), and each of the sections (e.g., parts) is defined as a first group or a second group. For example, the first through (3n)^{th} gate lines G1 through G3n, disposed sequentially on the display panel 300, are divided into three sections A, B and C. That is, the first through n^{th} gate lines G1 through Gn may be included in section A, the (n+1)^{th} through (2n)^{th} gate lines G(n+1) through G2n may be included in section B, and the (2n+1)^{th} through (3n)^{th} gate lines G(2n+1) through G3n may be included in section C. For ease of description, the sections A, B and C will hereinafter be referred to as parts A, B and C, respectively.

In an exemplary embodiment, the part A and the part C are included in the first group, and the part B is included in the second group. Thus, although the part A and the part B are adjacent to each other, part A may be in the first group while the part B is in the second group. Likewise, although the parts B and the part C are adjacent to each other, the part B is in the second group while the part C is in the first group.

An order in which the first gate signals are sequentially and respectively transmitted to gate lines included in the first group is different from an order in which the first gate signals are sequentially and respectively transmitted to gate lines included in the second group. Specifically, the order in which the first gate signals are sequentially and respectively transmitted to the first through n^{th} gate lines G1 through Gn (included in the part A, which is in the first group) and the order in which the first gate signals are sequentially and respectively transmitted to the (2n+1)^{th} through (3n)^{th} gate lines G(2n+1) through G3n (included in the part C, which is in the first group) are different from the order in which the first gate signals are sequentially and respectively transmitted to the (n+1)^{th} through (2n)^{th} gate lines G(n+1) through G2n (included in the part B, which is in the second group). More particularly, the first gate signals may sequentially and respectively be transmitted to the first through n^{th} gate lines G1 through Gn in a first order, to the (2n)^{th} through (n+1)^{th} gate lines G2n through G(n+1) in a second order, and to the (2n+1)^{th} through (3n)^{th} gate lines G(2n+1) through G3n in a third order, as will be described in further detail below with reference to FIG. 4.

As will also be described in further detail below, the signal controller 600 receives original image signals R, G and B and outputs display data signals DAT to the data driver 500. Moreover, the data driver 500 outputs data voltages (e.g., the normal data voltages and the impulsive data voltages) which correspond to the display data signals DAT. Specifically, the signal controller 600 may receive the original image signals R, G and B, change an arrangement order of the original image signals R, G and B based on the order in which the first gate signals are sequentially and respectively transmitted to the first through (3n)^{th} gate lines G1 through G3n, as described above, and generate the normal data signals. Generating the normal data signals by changing the arrangement order of the original image signals R, G and B will be described in further detail below with reference to FIG. 8.

As shown in FIG. 1, the display panel 300 according to an exemplary embodiment includes the pixels PX arranged in a substantially matrix pattern.

Referring now to FIG. 2, each of the pixels PX may be electrically connected to, for example, an i^{th} (where i=1 to 3n) gate line G1 and a j^{th} where (j=1 to m) data line Dj. In addition, each of the pixels PX may include a switching device Q, connected to the i^{th} gate line G1 and the j^{th} data line Dj, as well as a liquid crystal capacitor Clc and a storage capacitor Cst connected to the switching device Q. The liquid crystal capacitor Clc includes two electrodes, such as a pixel electrode PE disposed on a first substrate 100 and a common electrode CE disposed on a second substrate 200, for example, and liquid crystal molecules 150 interposed between the first substrate 100 and the second substrate. A color filter CF may be disposed proximate to the common electrode CE. In an exemplary embodiment, the storage capacitor Cst may be removed. In an exemplary embodiment, The common electrode CE may be disposed on the first substrate. And, the color filter CF may be disposed on the second substrate. In an exemplary embodiment, the color filter CF may be disposed on the first substrate. And the common electrode CE may be disposed on the second substrate. In an exemplary embodiment, the color filter CF may be disposed on the first substrate. And the common electrode CE may be disposed on the first substrate.

Referring again to FIG. 1, the signal controller 600 receives the original image signals R, G and B and external control signals for controlling the display of the original image signals R, G and B and outputs the display data signals DAT, gate control signals CONT1 and data control signals CONT2. More specifically, the signal controller 600 receives the original image signals R, G and B and outputs the display data signals DAT. The signal controller 600 may also receive the external control signals from an external source (not shown) and generates the gate control signals CONT1 and the data control signals CONT2. The external control signals include, for example, a vertical synchronization signal Vsync, a horizontal synchronization signal Hsync, a main clock signal Mclk and a data enable signal DE. The gate control signals CONT1 control an operation of the gate driver 400, while the data control signals CONT2 control an operation of the data driver 500. The signal controller 600 will be described in further detail below with reference to FIG. 3.

The gate driver 400 according to an exemplary embodiment receives the gate control signals CONT1 from the signal controller 600 and transmits the first gate signal and the second gate signal to the first through (3n)^{th} gate lines G1 through G3n. In an exemplary embodiment, the first gate signal and the second gate signal are a combination of a gate-on voltage Von and a gate-off voltage Voff provided by a gate on/off voltage generator (not shown). In an exemplary embodiment, for example, the first gate signals may be gate-on voltages corresponding to the normal image data, while the second gate signals may be gate-on voltages corresponding to the impulsive image data. An operation of the first gate signal and the second gate signal will be described in further detail below with reference to FIG. 4.

The data driver 500 receives the data control signals CONT2 from the signal controller 600 and transmits the data voltages, which correspond to the display data signals DAT, to the first through m^{th} data lines D1 through Dm. The data voltages corresponding to the display data signals DAT are provide from the grayscale voltage generator 700. In an exemplary embodiment, the display data signals DAT include the normal data signals and the impulsive data signals. As a result, the data voltages include the normal data voltages and the impulsive data voltages corresponding to the normal data signals and the impulsive data signals, respectively. In an exemplary embodiment, the impulsive data signals are black data signals, for example, but alternative exemplary embodiments are not limited thereto.

The grayscale voltage generator 700 according to an exemplary embodiment divides a driving voltage AVDD into a plurality of data voltages based on gray levels of the display data signals and provides the data voltages to the data driver 500. The grayscale voltage generator 700 may include a plurality of resistors (not shown) connected in electrical series with each other between a node, to which the driving voltage AVDD is applied, and a ground source. Thus, the grayscale voltage generator 700 divides a level of the driving voltage AVDD to generate a plurality of grayscale voltages. An internal circuit of the grayscale voltage generator 700 is not limited to the above mentioned example, and may be implemented in various ways in alternative exemplary embodiments. In an exemplary embodiment, the grayscale voltage generator 700 may divides a driving voltage AVDD into a plurality of gray reference voltages. And the gray reference voltages may be provided to the data driver 500. And the data driver 500 may divide the gray reference voltages into the data voltages corresponding to the display data signals.

Referring now to FIG. 3, the signal controller 600 includes an image signal processor 610 and a control signal generator 620.

The image signal processor 610 receives the original image signals R, G and B and outputs the display data signals DAT. As described above, the display data signals DAT include the normal data signals and the impulsive data signals. In addition, the image signal processor 610 changes the arrangement order of the original image signals R, G and B based on the order in which the first gate signals are sequentially and respectively transmitted to the first through (3n)^{th} gate lines G1 through G3n, and thereby generates the normal data signals.

More specifically, the order in which the first gate signals are sequentially and respectively transmitted to the gate lines in the first group is different from the order in which the first gate signals are sequentially and respectively transmitted to the gate lines in the second group. Thus, to transmit the normal data signals to the pixels PX which are electrically connected to the first through (3n)^{th} gate lines G1 through G3n, the normal data signals are sequentially and respectively transmitted to the pixels PX based on the order in which the first gate signals are sequentially and respectively transmitted to the first through (3n)^{th} gate lines G1 through G3n. The image signal processor 610 and the normal data signals will be described in further detail below with reference to FIG. 8.

In an exemplary embodiment, the display data signals DAT may be corrected by an additional process to substantially improve display quality.

The control signal generator 620 receives the external control signals (such as the data enable signal DE, the horizontal synchronization signal Hsync, the vertical synchronization signal Vsync and the main clock signal Mclk, for example) from an external source (not shown) and outputs the gate control signals CONT1 and the data control signals CONT2.

The gate control signals CONT1 control an operation of the gate driver 400. The gate control signals CONT1 may include, for example, a vertical start signal STV for starting the gate driver 400, a gate clock signal CPV for determining when to output the gate-on voltage Von and an output enable signal OE for determining a pulse width of the gate-on voltage Von.

The data control signals CONT2 control an operation of the data driver 500. The data control signals CONT2 may include, for example, a horizontal start signal STH for starting the data driver 500 and an output instruction signal TP for instructing output of the image data voltage.

The first gate signal and the second gate signal transmitted to the first through (3n)^{th} gate lines G1 through G3n will now be described in further detail with reference to FIG. 4.

Referring to FIG. 4, the first through (3n)^{th} gate lines G1 through G3n are divided into the three parts A, B and C, each being included in one of the first group or the second group, as described above. Accordingly, an order in which the first gate signals are sequentially transmitted to the gate lines in each of the parts A, B and C is determined. More specifically, the first through n^{th} gate lines G1 through Gn are included in the part A, the (n+1)^{th} through (2n)^{th} gate lines G(n+1) through G2n are included in the part B and the (2n+1)^{th} through (3n)^{th} gate lines G(2n+1) through G3n are included in the part C. In addition, the parts A and C are defined as being in the first group, while the part B is defined as being in the second group.

In FIG. 4, reference character “A1” indicates the part A, defined as being in the first group, reference character “B2” indicates the part B, defined as being in the second group and reference character “C1” indicates the part C, defined as being in the first group. Division of the first through (3n)^{th} gate lines G1 through G3n as shown in FIG. 4 is according to an exemplary embodiment, and a number of parts into which the first through (3n)^{th} gate lines G1 through G3n are divided and/or a number of gate lines included in each part is not limited thereto in alternative exemplary embodiments.

In an exemplary embodiment, the first group and the second group are adjacent to each other. More particularly, when a plurality of the gate lines are sequentially arranged on the display panel 33 and are divided into two or more groups, one of the groups is defined as a first group, and an adjacent successive group, relative to the first group, is therefore defined as a second group. Thus, the first group and the second group are defined in the above mentioned order. Conversely, when the first group, as defined above, is defined as the second group, and an adjacent and successive to the second group is therefore defined as the first group. Put another way, the groups may be defined according to an order of the second group and the first group.

The first through (3n)^{th} gate lines G1 through G3n receive the first gate signal and the second gate signal such that the normal data voltages and the impulsive data voltages, respectively, are applied to the pixels PX which are electrically connected to the first through (3n)^{th} gate lines G1 through G3n. More specifically, the pixels PX receive the normal data voltages in response to the first gate signals, and receive the impulsive data voltages in response to the second gate signals. As a result, the pixels PX display images, which respectively correspond to the normal and impulsive data voltages, on the display panel 300. In an exemplary embodiment, the first gate signals (indicated by reference character “N” in FIG. 4) include the gate-on voltages corresponding to the normal image data, and the second gate signals (indicated by reference character “B” in FIG. 4) include the gate-on voltages corresponding to the impulsive image data.

The first gate signals are transmitted to the first through (3n)^{th} gate lines G1 through G3n. In an exemplary embodiment, an order in which the first gate signals are sequentially and respectively transmitted to the first through (3n)^{th} gate lines G1 through G3n is determined according to the group (e.g., the first group or the second group) to which the first through (3n)^{th} gate lines G1 through G3n belong. For example, in an exemplary embodiment the first group includes a^{th} through m^{th} gate lines disposed sequentially on the display panel 300, and the first gate signals are sequentially transmitted to the a^{th} through m^{th} gate lines in this order. In addition, the second group includes n^{th} through x^{th} gate lines disposed sequentially on the display panel 300, and the first gate signals are sequentially be transmitted to the x^{th} through n^{th} gate lines.

Referring to the part A1 of FIG. 4, part Al, which is defined as being in the first group, includes the first through n^{th} gate lines G1 through Gn, and the first gate signals N are sequentially transmitted to the first through n^{th} gate lines G1 through Gn in a first order, shown in FIG. 4. In addition, the second gate signals B are simultaneously transmitted to the first through n^{th} gate lines G1 through Gn. As described in greater detail above, the normal data voltages are transmitted to the pixels PX, which are electrically connected to the first through n^{th} gate lines G1 through Gn, in response to the first gate signals N, and the impulsive data voltages are transmitted to the pixels PX in response to the second gate signals B.

In an exemplary embodiment, the normal data voltages are charged in the pixels PX and are maintained until the second gate signals B are transmitted to the pixels PX after the first gate signals N are transmitted thereto. In an exemplary embodiment, a normal data output time is defined as a period of time which begins after a first gate signal N is transmitted to a given pixel PX and which ends before a second gate signal B is transmitted to the given pixel PX.

Still referring to FIG. 4, when a time unit during which a first gate signal is transmitted to each gate line is defined as one horizontal period 1H, the normal data output time of the first gate line G1 in the part A1 is defined as M·H. In an exemplary embodiment, M is a natural number. More specifically, M is a value obtained by dividing the normal data output time of the first gate line G1 (in part A1) by 1H. Thus, the normal data output time (M·H) of the first gate line G1 may be obtained by multiplying a section, which begins after one of the first gate signals N is transmitted to the first gate line G1 and ends before one of the second gate signals B is transmitted to the first gate line G1, by the time unit 1H during which the first gate signal N is transmitted to the first gate line G1. In an exemplary embodiment, for example, M may have a value greater than a number of the first through n^{th} gate lines G1 through Gn included in part A1.

As described in greater detail above, the first gate signals N are sequentially transmitted to the first through n^{th} gate lines G1 through Gn in part A1, and the second gate signals B are simultaneously applied to the first through n^{th} gate lines G1 through Gn in the part A1. Thus, the normal data output time is gradually reduced along the first through n^{th} gate lines G1 through Gn.

Specifically, referring to the part A1, the normal data output time of the second gate line G2 is (M−1)·H, which is shorter than the normal data output time (M·H) of the first gate line G1 by 1H, and the normal data output time of the third gate line G3 is ((M−2)·H), which is 1H shorter than the normal data output time ((M−1)·H) of the second gate line G2.

In addition, referring to the part B2, the normal data output time of the (n+1)^{th} gate line Gn+1is [M−(n−1)]H, and the normal data output time of the (2n)^{th} gate line G2n is M·H. Thus, the normal data output time (M·H) of the first gate line G1 in the part A1 is equal to normal data output time of the (2n)^{th} gate line G2n in the part B2, and the normal data output time ([M−(n−1)]·H) of the n^{th} gate line Gn in part A1 is equal to normal data output time of the (n+1)^{th} gate line Gn+1 in the part B2.

Moreover, the normal data output times of the (2n+1)^{th} through (3n)^{th} gate lines G(2n+1) through G3n in the part C1 are substantially equal to the normal data output times of the first through n^{th} gate lines G1 through Gn in part A1, respectively. Specifically, the normal data output time of the (2n+1)^{th} gate line G(2n+1) is M·H, and the normal data output time of the (3n)^{th} gate line G3n is [M−(n−1)]·H. Thus, the normal data output time of the (2n+1)^{th} gate line G(2n+1) in the part C1 is equal to the normal data output time of the (2n)^{th} gate line G2n in the part B2.

As a result, the order in which the first gate signals are sequentially provided to the gate lines varies according to whether the gate lines are included in the first group or the second group adjacent to the first group. Thus, the normal data output time is gradually reduced in an order from the first gate line G1 through the n^{th} gate line Gn in part A1, and then gradually increases in an order from the (n+1)^{th} gate line G(n+1) through the through the (2n)^{th} gate line G2n in part B2, and is thereafter again reduced in an order from the (2n+1)^{th} gate line G(2n+1) through the (3n)^{th} gate line G3n in part C1.

As shown in FIG. 4, one of the second gate signals B is transmitted to the first gate line G1 in a middle portion of a frame 1F, but alternative exemplary embodiments are not limited thereto. In addition, each part shown in the exemplary embodiment of FIG. 5 includes n gate lines, but alternative exemplary embodiments are not limited thereto. For example, each part may include a different number of gate lines than n.

The normal data output time and the impulsive data output time of each gate line will now be described in further detail with reference to FIG. 5. In FIG. 5, a given rectangle, labeled either “IMAGE” or “BLACK”, indicates a frame corresponding to a given gate line. More specifically, left rectangles in FIG. 5 indicate a normal data output time IMAGE, and right rectangles in FIG. 5 indicate an impulsive data output time BLACK. As described above, the normal data output time IMAGE of the part A1 is gradually reduced in the order of the first through n^{th} gate lines G1 through Gn, respectively, and the normal data output time IMAGE of the part B2 gradually increases in the order of the (n+1)^{th} through (2n)^{th} gate lines G(n+1) through G2n, respectively. In addition, the normal data output time IMAGE of the part C1 is gradually reduced similar as in the part A1. As shown in FIG. 5, gate lines in a boundary region, e.g. a region between two adjacent groups, such as for the n^{th} and (n+1)^{th} gate lines Gn and G(n+1), as well as for the (2n)^{th} and (2n+1)^{th} gate lines G(2n) and G(2n+1), have the same normal data output time IMAGE.

As a result, referring to FIG. 6, gate lines in a boundary region between two groups have a same normal data output time, and a brightness difference between pixels PX (FIG. 1) electrically connected to two corresponding gate lines is substantially reduced. In FIG. 6, a horizontal axis represents gate line numbers, and a vertical axis represents a brightness corresponding to gate lines represented by the gate line numbers in the horizontal axis.

As a period of time during which black data is transmitted to each gate line increases, a brightness of each gate line is reduced. When the brightness of the first gate line G1, having a relatively long normal data output time, is B_{H} and when the brightness of the n^{th} gate line Gn, having a short normal data output time relative to the first gate line G1, is BL, the brightness of the first through (3n)^{th} gate lines G1 through G3n fluctuates between B_{H} and B_{L}, as shown in FIG. 6. Specifically, the brightness of the first through n^{th} gate lines G1 through Gn gradually decreases from B_{H} to B_{L}, the brightness of the (n+1)^{th} through (2n)^{th} gate lines G(n+1) through G2n gradually increases from B_{L} to B_{H}, and the brightness of the (2n+1)^{th} through (3n)^{th} gate lines G(2n+1) through G(3n) again decreases, as shown in FIG. 6. As shown in FIG. 6, the brightness of the n^{th} gate line Gn is substantially equal to the brightness of the (n+1)^{th} gate line G(n+1), and the brightness of the (2n)^{th} gate line G2n is equal to the brightness of the (2n+1)^{th} gate line G(2n+1). In addition, the brightness change between adjacent gate lines is small relative to other brightness changes. Thus, a problem in which bright lines, caused by a sharp brightness change, are substantially reduced in an LCD 10 according to an exemplary embodiment, since there is no sharp increase or decrease in the brightness of the first through (3n)^{th} gate lines G1 through G3n, thereby substantially enhancing a display quality in the LCD 10.

Furthermore, when a number of the gate lines included in each group increases, gate lines in a boundary region between two adjacent groups have similar brightness levels in the LCD 10 according to an exemplary embodiment. Thus, the second gate signals need not be provided at different times, which results in a substantially reduction in a driving frequency required by the gate driver 400.

Images displayed on the display panel 300 according to an operation of the first through (3n)^{th} gate lines G1 through G3n will now be described in further detail with reference to FIG. 7.

In FIG. 7, each rectangle indicates a stage of the display panel 300, and reference characters “A,” “B” and “C” indicate corresponding parts, which corresponding groups is including. And each group include corresponding gate lines. As described above, the gate lines are divided into the first group and the second group, and pixels PX (FIG. 1) are electrically connected to gate lines which receive data voltages to display images on the display panel 300. In an exemplary embodiment and as shown in FIG. 7, the first group includes part A, and part C. And the second group includes a part B. The gate lines are divided into corresponding parts A, B and C of the display panel 300 (FIG. 1). In addition, arrows in FIG. 7 indicate a direction in which the first gate signals N (FIG. 4) are sequentially transmitted to corresponding gate lines in each of the parts A, B, and C, e.g., indicate a direction in which images are displayed on the display panel 300. For example, at a first stage Frame1-1 of a first frame, the first gate signals N are sequentially transmitted to gate lines in part A in an order from highest to lowest gate lines in FIG. 7. Thus, images are sequentially displayed in a downward direction (in FIG. 7) in part A of the display panel 300. In FIG. 7 hatching indicates when the impulsive data signals are transmitted to the pixels PX. In an exemplary embodiment, for example, black data is transmitted to the pixels PX as the impulsive data signals, indicated by the hatched area in FIG. 7, and thus an image is not displayed on the display panel 300 in the hatched areas shown in FIG. 7.

Referring to FIG. 7, at the first stage Frame1-1 of the first frame, images are displayed in a first direction a (in the part A) of the display panel 300, and images are displayed in a second direction b, substantially opposite to the first direction a, in the part B, and impulsive image data is displayed in the part C. In an exemplary embodiment, the first through n gate lines G1 through Gn in part A sequentially receive the first gate signals N (FIG. 4) in the first direction a while the (n+1)^{th} through (2n)^{th} gate lines G(n+1) through G2n in part B sequentially receive the first gate signals N in the second direction b. In addition, the (2n+1)^{th} through (3n)^{th} gate lines G(2n+1) through G(3n) in the part C receive the second gate signals B (FIG. 4).

During a second stage Frame1-2 of the first frame, an image is not displayed in the part A, and images are sequentially displayed in the second direction b in the part B while images are sequentially displayed in the first direction a in the part C. Likewise, during a third frame Frame1-3 of the first frame, images are sequentially displayed in the direction “a” in part the A, and the impulsive image data is displayed in the part B while images are sequentially displayed in the direction “a” in the part C. During a first stage Frame 2-1 of a second frame, the first stage Frame 1-1 of the first frame is repeated. In an exemplary embodiment, displaying the impulsive image data includes displaying a black image, e.g., no image.

Thus, as shown in FIG. 7, a plurality of gate lines are divided into the parts A through C, and the parts A and C are defined as being in the first group while part B is defined as being in the second group. The first gate signals N are sequentially transmitted to gate lines of the parts A and C in the first direction a while the first gate signals N are sequentially transmitted to gate lines of the part B in the second direction b. As shown in the exemplary embodiment shown in FIG. 7, the first direction a and the second direction b are opposite directions, but the first direction a is not necessarily a downward direction (as viewed in FIG. 7), and the second direction b is not necessarily always an upward direction (as viewed in FIG. 7). More particularly, the first gate signals N are sequentially transmitted to gate lines of the first group and the second group in different orders. In an exemplary embodiment, for example, after the first gate signals N are sequentially transmitted to the gate lines in the part A (which is in the first group), the first gate signals N are sequentially transmitted to the gate lines in the part B (which is in the second group) in a reverse order relative to in the Part A. Similarly, after the first gate signals N are sequentially transmitted to the gate lines in the part B, the first gate signals N are sequentially transmitted to the gate lines in the part C (which is in the first group) in a same order as in part A.

Referring now to FIG. 8, the signal controller 600 according to an exemplary embodiment receives the original image signals R, G and B, changes an order, e.g., an arrangement order, of the original image signals R, G and B based on an order in which the first gate signals N (FIG. 4) are sequentially transmitted to corresponding gate lines, and generates the normal data signals. As shown in an upper portion of FIG. 8, a label DAT′ indicates a data arrangement order of the original image signals R, G and B, while the display image signals labeled DAT, into which the data arrangement order of the original image signals R, G and B is changed, are shown in a lower portion of FIG. 8. In addition, each hexagon shown in FIG. 8 indicates a data signal provided to pixels PX which are electrically connected to the gate lines. And, labels “Da”, “Db”, and “Dc” indicate normal data signals corresponding to the Part A, the Part B, and the Part C, respectively. As described in further detail above, when the first through n^{th} gate lines G1 through Gn are included in the part A, the (n+1)^{th} through (2n)^{th} gate lines G(n+1) through G2n are included in the part B, and the (2n+1)^{th} through (3n)^{th} gate lines G(2n+1) through G3n are included in the part C, the parts A an C are defined as the first group, while the part B is defined as the second group.

According to exemplary embodiments of the present invention, the normal data voltages are transmitted to the pixels PX in response to the first gate signals N. Thus, the signal controller 600 changes a data arrangement order of the original image signals R, G and B based on the order in which the first gate signals N are sequentially transmitted corresponding gate lines and then generates the normal data signals.

The original image signals R, G and B according to an exemplary embodiment are arranged to correspond to sequentially arranged gate lines, e.g., the first through (3n)^{th} gate lines G1 through G3n disposed on the display panel 300. Thus, the original signals R, G and B are arranged to correspond respectively to the first through (3n)^{th} gate lines G1 through G3n, regardless of an arrangement of the parts A, B and C, into which the first through (3n)^{th} gate lines G1 through G3n are divided. As shown in FIG. 8, data signals corresponding to the first through n^{th} gate lines G1 through Gn in the part A are sequentially arranged, data signals corresponding respectively to the (n+1)^{th} through (2n)^{th} gate lines G(n+1) through G2n in the part B are sequentially arranged, and data signals corresponding respectively to the (2n+1)^{th} through (3n)^{th} gate lines G(2n+1) through G3n in the part C are sequentially arranged.

Thus, the signal controller 600 according to an exemplary embodiment changes the data arrangement order of the original image signals R, G and B which corresponds to the arrangement order of the first through (3n)^{th} gate lines G1 through G3n to the data arrangement order which corresponds to the order in which the first gate signals are sequentially and respectively transmitted to the first through (3n)^{th} gate lines G1 through G3n. To this end, the arrangement order of the normal data signals of the display image signals DAT corresponds to the order in which the first gate signals are sequentially transmitted to the first through (3n)^{th} gate lines G1 through G3n.

More specifically, as shown in FIG. 8, the signal controller 600 maintains the arrangement order of the data signals for parts A and C while the signal controller 600 reverses the arrangement order of the data signals for part B. As described in greater detail above, since the (n+1)^{th} through (2n)^{th} gate lines G(n+1) through G2n are sequentially disposed on the display panel 300 and are defined as the second group, the first gate signals N are sequentially transmitted to the (2n)^{th} through (n+1)^{th} gate lines G2n through G(n+1) in the order shown in FIG. 8. Thus, the arrangement order of the original images R, G and B is changed to match an arrangement order corresponding to the order in which the first gate signals N are sequentially transmitted to the (2n)^{th} through (n+1)^{th} gate lines G2n through G(n+1).

As shown in FIG. 8, a plurality of gate lines are divided into three groups (e.g., parts A, B and C), and parts A and C are defined as being in the first group while part B is defined as being in the second group. It will be noted, however, that alternative exemplary embodiments are not limited to the arrangement shown in FIG. 8 and described above. For example, the gate lines in an alternative exemplary embodiment may be divided into a greater number of groups and, alternatively, part A may be defined as being the second group. As described above, the first group and the second group are adjacent to each other.

According to exemplary embodiments of the present invention as described herein, an LCD includes advantages which include, but are not limited to, substantially improved display quality.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, the exemplary embodiments described herein should be considered in a descriptive sense only and not for purposes of limitation. Moreover, it will be understood by those of ordinary skill in the art that various changes in form and detail may be made therein without departing from the spirit or scope of the present invention as defined by the following claims.

What is claimed is:

1. A display apparatus comprising:
a display panel comprising:
a substrate;
gate lines;
data lines which cross the gate lines; and
pixels connected to the gate lines and the data lines, the pixels displaying an image;
a gate driver connected to the gate lines, the gate driver transmitting a first gate signal and a second gate signal to the gate lines; and
a data driver connected to the data lines, the data driver transmitting normal data voltages and impulsive data voltages to the data lines, wherein
the pixels receive the normal data voltages in response to the first gate signal,
the pixels receive the impulsive data voltages in response to the second gate signal,
the gate lines are divided into at least one first group and at least one second group,
the at least one first group is disposed adjacent to the at least one second group, and
an first order in which the first gate signal is transmitted to the gate lines in the at least one first group is different from an second order in which the first gate signal is transmitted to the gate lines in the at least one second group.

2. The display apparatus of claim 1, wherein
the at least one first group comprises a-th through m-th gate lines disposed sequentially on the substrate,
the first gate signal is transmitted sequentially to each of the a-th through m-th gate lines,
the at least one second group comprises n-th through x-th gate lines disposed sequentially on the substrate,
the first gate signal is transmitted sequentially to each of the x-th through n-th gate lines,
a, m, n and x are natural numbers,
a is less than m, and
n is less than x.

3. The display apparatus of claim 2, wherein
a normal data output time begins after the first gate signal is transmitted and ends before the second gate signal is transmitted, and
the normal data output time of the a-th gate line in the at least one first group is equal to the normal data output time of the x-th gate line in the at least one second group.

4. The display apparatus of claim 3, wherein the normal data output time of the m-th gate line in the at least one first group is equal to the normal data output time of the n-th gate line in the at least one second group.

5. The display apparatus of claim 4, wherein a number of the gate lines included in the at least one first group is equal to a number of the gate lines included in the at least one second group.

6. The display apparatus of claim 1, further comprising a signal controller, wherein
the signal controller receives original image signals, and
the signal controller generates normal data signals, which are corresponding to the normal data voltages, by changing an order of the original image signals based on at least one of the first order in which the first gate signal is transmitted to the gate lines in the at least one first group and the second order in which the first gate signal is transmitted to the gate lines in the at least one second group.

7. The display apparatus of claim 6, wherein
the at least one second group comprises n-th through x-th gate lines disposed sequentially on the substrate,
the signal controller changes the order of the original image signals to generate the normal data signals based on an arrangement order of the n-th through x-th gate lines,
n and x are natural numbers, and
n is less than x.

8. The display apparatus of claim 1, wherein the gate lines in the at least one first group simultaneously receive the second gate signal at a first time which is different from a second time when the gate lines in the at least one second group simultaneously receive the second gate signal.

9. A display apparatus comprising:
a display panel comprising:
a substrate;
gate lines;
data lines which cross the gate lines; and
pixels connected to the gate lines and the data lines, the pixels displaying an image;
a gate driver connected to the gate lines, the gate driver transmitting a first gate signal and a second gate signal to the gate lines;
a data driver connected to the data lines, the data driver transmitting normal data voltages and impulsive data voltages to the data lines; and
a signal controller, wherein
the pixels receive the normal data voltages in response to the first gate signal,
the pixels receive the impulsive data voltages in response to the second gate signal,
the gate lines are divided into at least one first group and at least one second group,
the at least one first group is disposed adjacent to the at least one second group,
an first order in which the first gate signal is transmitted to the gate lines in the at least one first group is different from an second order in which the first gate signal is transmitted to the gate lines in the at least one second group,
the signal controller receives original image signals, and
the signal controller generates the normal data signals, which are corresponding to the normal data voltages, by changing an order of the original image signals based on at least one of the first order in which the first gate signal is transmitted to the gate lines in the at least one first group and the second order in which the first gate signal is transmitted to the gate lines in the at least one second group.

10. The display apparatus of claim 9, wherein the gate lines in the at least one first group simultaneously receive the second gate signal at a first time which is different from a second time when the gate lines in the at least one second group simultaneously receive the second gate signal.

11. A method of driving a display apparatus, the method comprising:
providing a display panel comprising:
a substrate;
gate lines:
data lines which cross the gate lines: and
pixels connected to the gate lines and the data lines, the pixels displaying an image;
transmitting a first gate signal and a second gate signal to the gate lines; and
transmitting normal data voltages and impulsive data voltages to the data lines, wherein
the pixels receive the normal data voltages in response to the first gate signal,
the pixels receive the impulsive data voltages in response to the second gate signal,
the gate lines are divided into at least one first group and at least one second group,
the at least one first group is disposed adjacent to the at least one second group, and
an first order in which the first gate signal is transmitted to the gate lines in the at least one first group is different from an second order in which the first gate signal is transmitted to the gate lines in the at least one second group.

12. The method of claim 11, wherein
the at least one first group comprises a-th through m-th gate lines disposed sequentially on the substrate,
the transmitting the first gate signal to the gate lines comprises sequentially transmitting the first gate signal to each of the a-th through m-th gate lines,
the at least one second group comprises n-th through x-th gate lines disposed sequentially on the substrate,
the transmitting the first gate signal to the gate lines comprises further comprises sequentially transmitting the first gate signal to each of the x-th through n-th gate lines,
a, m, n, and x are natural numbers,
a is less than m, and
n is less than x.

13. The method of claim 12, wherein
a normal data output of time begins after the first gate signal is transmitted to the gate lines and ends before the second gate signal is transmitted to the gate lines, and
the normal data output time of the a-th gate line in the at least one first group is equal to the normal data output time of the x-th gate line in the at least one second group.

14. The method of claim 13, wherein the normal data output time of the m-th gate line in the at least one first group is equal to the normal data output time of the n-th gate line in the at least one second group.

15. The method of claim 14, wherein a number of the gate lines included in the at least one first group is equal to a number of the gate lines included in the at least one second group.

16. The method of claim 11, wherein the transmitting the normal data voltages comprises:
receiving original image signals; and
generating normal image signals by changing an order of the original image signals based on an order in which the first gate signal is transmitted to the gate lines, wherein
the normal image signals correspond to the normal image voltages.

17. The method of claim 16, wherein
the at least one second group comprises n-th through x-th gate lines disposed sequentially on the substrate,
the changing of the order of the original image signals is based on an arrangement of the n-th through x-th gate lines on the substrate,
n and x are natural numbers, and
n is less than x.

18. The method of claim 11, wherein the transmitting of the second gate signal comprises:
simultaneously transmitting the second gate signal to the gate lines in the at least one first group at a first time; and
simultaneously transmitting the second gate signal to the gate lines in the at least one second group, wherein the first time is different from the second time.

19. The method of claim 11, wherein the transmitting the first gate signal and the second gate signal to the gate lines is repeated in units of frames.

20. The method of claim 11, wherein the impulsive data voltages comprise black data.
